(19) United States
(12) Patent Application Publication
(10) Pub. No.: US 2003/0093270 A1
(43) Pub. Date: May 15, 2003

(54) Comfort noise including recorded noise

(76) Inventor: Steven M. Domer, Mesa, AZ (US)

Correspondence Address: Paul F. Wille, 6407 East Clinton St., Scottsdale, AZ, 85254, US

(21) Appl. No.: 10/008,826

(22) Filed: Nov. 13, 2001

(51) Int. Cl. G10L 21/02

(52) U.S. Cl. 704/227

(57) ABSTRACT

A short period of background noise is recorded during a call and then played back during non-speech intervals, thereby matching as nearly as possible the spectrum and amplitude of actual background noise during the call. Segments of the recording are played back in random order to mask repetition. Recording can take place more than once during a single call or take place in more than one session. In accordance with another aspect of the invention, a small amount of white noise is added to the recorded noise to improve the randomness of the sound.

### BACKGROUND OF THE INVENTION

This invention relates to a noise generator for use in speaker phones and other communication devices wherein it is desired to avoid complete silence during a communication.

Anyone who has used current models of speaker phones is well aware of the cut off speech and the silent periods during a conversation caused by echo canceling circuitry within the speaker phone. Such phones generally operate in what is known as half-duplex mode, which means that only one person can speak at a time. While such silent periods assure that the sound from the speaker is not coupled directly into the microphone within a speaker phone, the quality of the call is poor.

Whether or not to receive (listen) or transmit (talk) is not easily resolved in the particular application of telephone communication. Analyzing a voice signal in real time and deciding whether or not a person has finished speaking is a complex problem despite the ordinary human experience of doing it unconsciously or subconsciously. A variety of voice activity detectors have been proposed in the art.

Once it is decided that there is no voice activity in a channel, systems of the prior art imposed a silence in an attempt to eliminate acoustic and electronic echoes. The silence was interpreted by consumers as the connection having been interrupted and a party to a call would mistakenly hang up. This problem has been solved by providing so-called “comfort noise” in which a low level noise signal is applied to a line rather than silence. U.S. Pat. No. 6,122,611 (Su et al.) describes a system that not only adds noise during periods of silence but also adds a little noise during conversation to avoid changes in the apparent loudness of the speech.

While one might think that all noise is the same, such is not the case. An automobile produces quite a different background noise from an office or a living room full of people. Adding “white” (essentially purely random) noise produces yet another background sound. U.S. Pat. No. 5,657,422 (Janiszewski et al.) discloses processing the noise to make it sound more “natural.” Switching from natural background noise during speech to artificially generated noise during non-speech intervals can be annoying because the sounds are different.

In view of the foregoing, it is therefore an object of the invention to provide an improved generator of comfort noise.

Another object of the invention is to provide a more natural sounding comfort noise.

A further object of the invention is to provide a comfort noise that matches actual background noise as closely as possible.

### SUMMARY OF THE INVENTION

The foregoing objects are achieved in this invention in which a short period of background noise is recorded during a call and then played back during non-speech intervals, thereby matching as nearly as possible the spectrum and amplitude of actual background noise during the call. Segments of the recording are played back in random order to mask repetition. Recording can take place more than once during a single call or in more than one session. In accordance with another aspect of the invention, a small amount of white noise is added to the recorded noise to improve the randomness of the sound. In accordance with a further aspect of the invention, actual background noise is attenuated but not eliminated and is added to the output signal as a third component.

### BRIEF DESCRIPTION OF THE DRAWINGS

A more complete understanding of the invention can be obtained by considering the following detailed description in conjunction with the accompanying drawings, in which:

FIG. 1 is a block diagram of a comfort noise generator constructed in accordance with a preferred embodiment of the invention;

FIG. 2 is a block diagram of a comfort noise generator constructed in accordance with another aspect of the invention; and

FIG. 3 is a block diagram of a telephone incorporating a comfort noise generator constructed in accordance with a preferred embodiment of the invention.

### DETAILED DESCRIPTION OF THE INVENTION

An audio input signal is converted into digital samples by suitable apparatus (not shown in FIG. 1) and the samples are coupled to input 11, which is the data input for random access memory (RAM) 12. An eight kHz clock signal is coupled to input 14 of counter 15 to control timing. Alternate sixteen-bit samples are read into RAM 12, effectively sampling at a four kilohertz rate. One kilobyte of memory was used in one embodiment of the invention, providing approximately two hundred and fifty milliseconds of audio. A larger memory provides a longer recording time. The output from counter 15 is a ten bit address at which data is stored. During recording, data is stored in consecutive addresses, beginning at address zero, under the control of a read/write signal on input 16.

A second input to counter 15 is a ten-bit random number from random number generator 18. During a read operation, random number generator 18 applies data to counter 15, which is coupled to RAM 12 as the ten-bit start address of a read. Data is read sequentially until another count is received from random number generator 18. The result is that small segments of the recorded signal are randomly reproduced. The random read significantly reduces any periodic artifacts in the recorded signal from appearing in the data stream while emulating the spectral content and amplitude of the actual background noise very well.

In one embodiment of the invention, the recorded signal was divided into either eight or sixteen segments. The result is that the data stream from RAM 12 does not repeat for four or eight seconds. Using a one kilobyte RAM, eight segments each include one hundred twenty-eight bytes. A segment can begin anywhere. The segments do not align with the beginning or end of the address space of the RAM, except by chance. For example, a segment can begin at 3E8H (1000 decimal) and continue past zero to address 067H (103 decimal). Address counter 15 simply rolls over. It does not stop at 3FFH (1023 decimal) or at zero.

Recording actual background noise during a telephone call can take place more than once during a single call and can be made in more than one recording session, under the control of the read/write signal on input 16. Recording is stopped by voice activity detectors (not shown), known per se in the art, coupled to suitable logic for generating the read/write signal. If RAM 12 is not filled, more background noise is recorded at the next opportunity. Usually, 250 ms of background noise is easily obtained and one can omit the logic or software, not shown, for determining whether or not RAM 12 was filled. In accordance with another aspect of the invention, multiplex circuit 21 receives data from register 22 and from RAM 12 and couples either one or the other to the signal input of digital gain attenuator 25. The gain of attenuator 25 is controlled by register 26. The output from attenuator 25 is either the comfort noise from RAM 12 or a zero level signal from register 22.

Periodic background noise, such as music, is noticeably different even from a random signal incorporating a recording of the background sound in accordance with the invention. Thus, the circuit shown in FIG. 1 includes enable input 28 coupled to multiplex circuit 21. If loud, periodic background noise is detected by suitable apparatus (not shown), the comfort noise signal is preferably disabled and a low level signal is coupled to attenuator 25. The signal from comfort noise circuit 10 is ultimately added to the signal on either the line out side of a telephone or on the speaker out side, or both (two comfort noise circuits). Using the all zero data from register 22 essentially passes the actual background noise and, in effect, disables the comfort noise circuit.

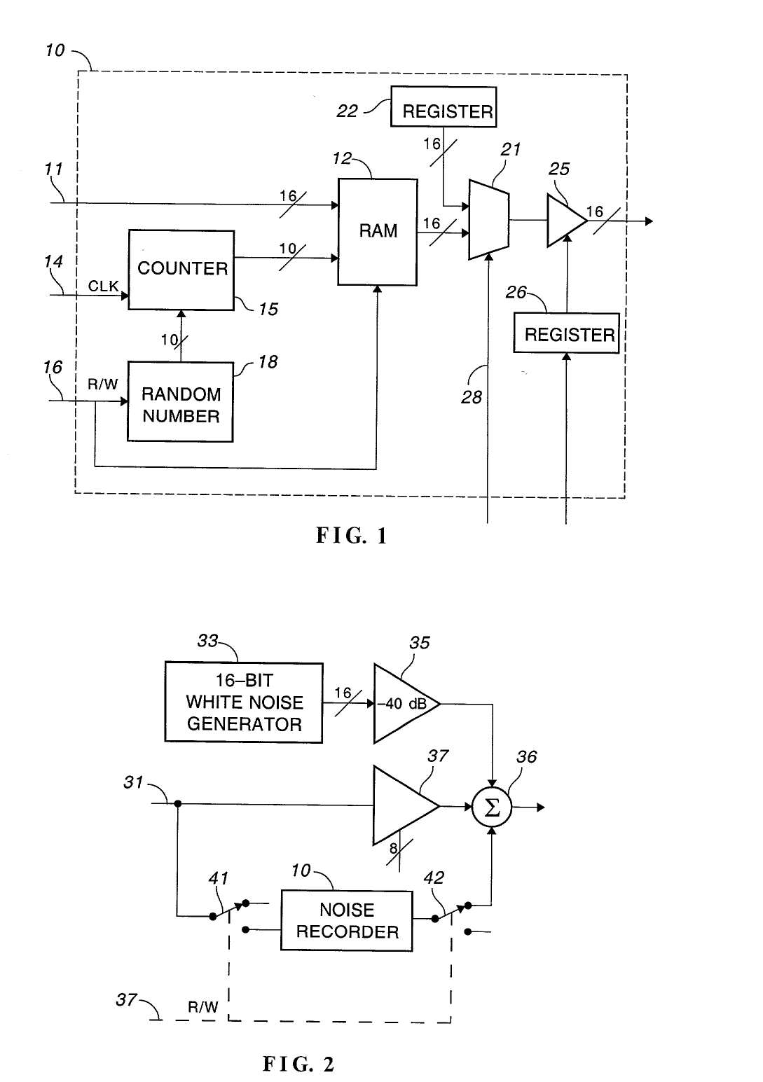

FIG. 2 illustrates another aspect of the invention in which white or colored (filtered) noise is added to the recorded noise to provide a comfort noise signal. Noise recorder 10 is the circuit illustrated in FIG. 1. White noise generator 33 provides a sixteen bit random signal that is coupled to attenuator 35, which preferably sets the amplitude of the signal to −40 dB relative to a system level of zero dB. The signal from attenuator 35 is added to the signal from comfort noise circuit 10, which is at a level determined by register 26 (FIG. 1), in summation circuit 36.

The combined signal further randomizes the comfort noise while closely replicating the actual incoming background noise. Read/write input 37 preferably switches both the input and the output of noise recorder 10 for recording or playback (the position shown for ganged, single pole double throw switches 41 and 42). Switches 41 and 42 are actually implemented in logic rather than the physical switches as illustrated.

A signal on input 31 representing the actual background noise is coupled through programmable attenuator 37 to another input of summation circuit 36. The actual background noise can be fully or partially attenuated and is preferably reduced to approximately the same level as the signals from attenuator 35 and recorder 10. The result is a very natural sounding background noise matching the amplitude and spectral content of the actual noise. The resulting comfort noise signal on the output of summation circuit 36 is sent to the line output or the speaker output of a telephone.

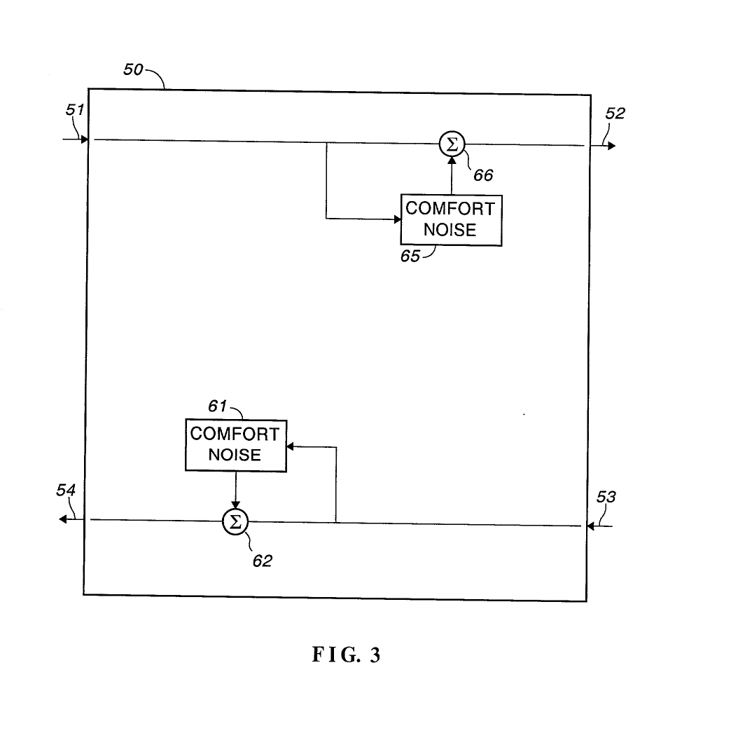

FIG. 3 is a block diagram of a telephone incorporating a comfort noise generator constructed in accordance with a preferred embodiment of the invention. Telephone 50 includes microphone input 51, line out 52, line in 53, and speaker out 54. A comfort noise generator is interposed in at least the receive side of the telephone, between line in 53 and speaker out 54. Comfort noise circuit 61 is constructed in accordance with either FIG. 1 or FIG. 2 and receives a signal from the line input, preferably after some processing (not shown) such as line echo cancellation. The output from comfort noise circuit 61 is combined with a signal from line input 53 in summation circuit 62 and coupled to speaker output 54.

Preferably, comfort noise is also used in the transmit side of the telephone. Comfort noise circuit 65 is constructed in accordance with either FIG. 1 or FIG. 2 and receives a signal from the microphone input, preferably after some processing (not shown) such as acoustic echo cancellation. The output from comfort noise circuit 65 is combined with a signal from microphone input 51 in summation circuit 66 and coupled to line out 52. Whether for transmit or receive, the comfort noise can be used continuously or only when no voice activity is detected.

The invention thus provides an improved circuit for generating comfort noise. The circuit provides a more natural sounding comfort noise that matches the spectrum and amplitude of the actual background noise as closely as possible while enabling one to fully control the signals within a system. The circuit is easily implemented in integrated circuit form and much of the control logic can be implemented in software rather than in hardware. Thus, the circuit is extremely flexible and can be adapted to existing telephones or incorporated into new designs.

Having thus described the invention, it will be apparent to those of skill in the art that various modifications can be made within the scope of the invention. For example, one can provide random segment lengths by having a first address from generator 18 be a start address and a second number from the generator be a stop address for each segment. A problem with this approach is that, on average, the segments will be as long as half of memory, which is not preferred. Rather than summing, one can switch between comfort noise and a line in signal or switch between comfort noise and a microphone input signal. The term “random” is not used herein in its strictly mathematical sense of a completely unpredictable event. Any finite counter can only produce a pseudo random number. As used herein, “random” means sufficiently random for its intended purpose. Although speaker phones are specifically identified for using the invention, the invention can be incorporated into any type of telephone or communication system where the ambiguity of silence must be eliminated. Although the data lines to the RAM are illustrated as separate for input and output, it is understood in the art that data lines to memory are typically bi-directional. Instead of summation circuits 62 and 66, one can use single pole double throw switches (or the equivalent logic) to switch comfort noise in or out of the circuit.

What is claimed as the invention is:

1. A method for providing a comfort noise signal in a telephone, said method comprising the steps of:
recording for a predetermined period the actual background noise occurring during a telephone call to produce a recorded signal;
playing back at least a portion of the recorded signal as comfort noise during the same telephone call.

2. The method as set forth in claim 1 wherein said playing back step includes the steps of:
dividing the recorded signal into segments;
reading the segments in random order.

3. The method as set forth in claim 1 wherein the recorded signal is digitally recorded in addressable memory capable of storing n bytes of data and said playing back step includes the steps of:
generating a start address;
applying the start address to the addressable memory;
reading m bytes from memory, wherein m<n.

4. The method as set forth in claim 3 wherein said generating step includes the steps of:
generating a random number; and
using at least a portion of the random number to create the start address.

5. The method as set forth in claim 3 wherein the steps recited in claim 3 are repeated for as long as desired but terminate with the telephone call.

6. The method as set forth in claim 1 and further including the steps of:
generating a random noise signal; and
combining the played back portion with random noise signal.

7. The method as set forth in claim 1 and further including the steps of:
generating a random noise signal;
attenuating the random noise signal;
attenuating the played back portion; and
combining the attenuated played back portion with the attenuated random noise signal.

8. The method as set forth in claim 1 and further including the steps of:
attenuating the actual background noise; and
combining the played back portion with attenuated actual background noise.

9. The method as set forth in claim 8 and further including the steps of:
generating a random noise signal;
attenuating the random noise signal;
attenuating the played back portion; and
combining the attenuated played back portion with the attenuated random noise signal and the attenuated actual background noise.

10. In a telephone circuit having digital data bus for audio signals and having a comfort noise generator coupled between a line input and a speaker output, the telephone circuit characterized by an improved comfort noise generator comprising:
random access memory having address lines, data lines, and control lines;
wherein one of said control lines determines whether data is written to said memory or read from said memory;
wherein said data lines are coupled to said data bus,
a counter coupled to said address lines, said counter having a data input and a clock input;
wherein said counter and said one control line cause said memory to store data representing a predetermined period the actual background noise occurring during a telephone call and to play back at least a portion of said data as comfort noise during the same telephone call.

11. The telephone circuit as set forth in claim 10 and further comprising:
a random number generator coupled to said address lines for generating a start address for reading data from said memory.

12. The telephone circuit as set forth in claim 11 and further comprising:
a white noise generator;
a summation circuit coupled to said white noise generator and to said memory for combining the white noise with the recorded data to produce a comfort signal.
